(19) United States
(12) Patent Application Publication
(10) Pub. No.: US 2004/0162927 A1
(43) Pub. Date: Aug. 19, 2004

(54) High speed multiple port data bus interface architecture

(75) Inventors: Anthony Joseph Benson, Roseville, CA (US); James J. deBlanc, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/370,358

(22) Filed: Feb. 18, 2003

(51) Int. Cl. G06F 13/00

(52) U.S. Cl. 710/301; 710/107

(57) ABSTRACT

A bus controller card capable of communicating high speed data between at least one host computer and at least one peripheral comprises a first bus segment connected between a first host connector, a first expander, a first card controller, a second expander, and a second host connector. A second bus segment extends from the first expander to a first backplane connector. A third bus segment extends from the second expander to a second backplane connector. At least one monitor bus segment is provided on the backplane to directly connect the first card controller to a second card controller on another bus controller card in the system. Each bus controller card is capable of determining whether cable connections to the bus interface card are properly mated; whether to enable an expander on the bus controller card; whether the bus controller card has primary or secondary status; and generating a signal to reset other components, including the other bus controller card, when one or more prespecified events are detected.

### RELATED APPLICATIONS

The disclosed system and operating method are related to subject matter disclosed in the following co-pending patent applications that are incorporated by reference herein in their entirety: (1) U.S. patent application Ser. No. ______, entitled “High Speed Multiple Ported Bus Interface Control”; (2) U.S. patent application Ser. No. ______, entitled “High Speed Multiple Ported Bus Interface Expander Control System”; (3) U.S. patent application Ser. No. ______, entitled “High Speed Multiple Ported Bus Interface Port State Identification System”; (4) U.S. patent application Ser. No. ______, entitled “System and Method to Monitor Connections to a Device”; (5) U.S. patent application Ser. No. ______, entitled “High Speed Multiple Ported Bus Interface Reset Control System”; and (6) U.S. patent application Ser. No. ______, entitled “Interface Connector that Enables Detection of Cable Connection.”

### BACKGROUND

A computing system may be connected to one or more peripheral devices, such as data storage devices, printers, and scanners. In a computing environment, an interface mechanism connects a computing system with the peripheral devices. The interface mechanism typically includes a data communication bus to which the devices and the computing system attach. The communication bus allows the computing system and the peripheral devices to communicate in an orderly manner. One or more communication buses may be utilized in a system.

Typically, a logic chip, known as a bus controller, monitors and manages data transmission between the computing system and the peripheral devices by prioritizing the order and the manner in which said devices take over and access the communication buses. In various interface mechanisms, control rules, also known as communication protocols, are implemented to promote the communication of information between computing systems and peripheral devices. For example, Small Computer System Interface or SCSI (pronounced “scuzzy”) is an interface mechanism that allows for the connection of multiple (e.g., up to 15) peripheral devices to a computing system. SCSI is widely used in computing systems, such as desktop and mainframe computers.

The advantage of SCSI in a desktop computer is that peripheral devices, such as scanners, CDs, DVDs, and Zip drives, as well as hard drives can be added to one SCSI cable chain. The distinct advantage of SCSI is its use in network servers where several hard drives can be easily configured as fault-tolerant clusters. That is, in the event one drive fails, it can be removed from the SCSI bus, and a new one inserted without loss of data even while the system continues to transfer data. A fault-tolerant communication system is generally designed to detect faults, such as power interruption or removal or insertion of peripherals, so that it can reset the appropriate system components to retransmit any lost data.

SCSI peripherals can be also daisy chained together. In a daisy chain environment an intermediate device has two ports. The first port connects to a computing system or another intermediate device attached to a computing system. The first port allows the device to communicate with the computing system. The second port is either terminated (i.e., not attached to anything) or attached to another device and allows for the computing system and the other device to communicate through the intermediate device. Thus, one or more devices can be attached in a line using a SCSI communication bus.

A SCSI communication bus uses the SCSI protocol for data communications. Hardware implementation of a SCSI communication bus is generally done using a 50 conductor flat ribbon or round bundle cable of characteristic impedance of 100 Ohm. Currently, a SCSI communication bus includes a bus controller included on a single expansion board that plugs into the host computing system. The expansion board is referred to as “Bus Controller Card (BCC),” as a “SCSI host adapter,”. or “SCSI controller card.”

In some embodiments, single SCSI host adapters are also available with two controllers that can support up to 30 peripherals. The SCSI host adapters can connect to an enclosure housing multiple devices. In the mid-range to high-end markets, the enclosure may have multiple controller “interface cards” or “controller cards” providing connection paths from the host adapter to SCSI buses resident in the enclosure. These controller cards can also provide bus isolation, configuration, addressing, bus reset, and fault detection functionalities for the enclosure. The controller card provides a connection path from the host adapter to the SCSI buses resident in the enclosure. The controller cards usually provide configuration, addressing, bus reset, and fault detection functionality for the enclosure.

One or more controller cards may be plugged in or unplugged from the backplane while data communication is in process. The insertion and removal of peripheral devices or controller cards to the backplane while the computing system is operating is referred to as “hot plugging.”

Single-ended and high voltage differential (HVD) SCSI interfaces have known strengths and weaknesses. Whereas single ended SCSI devices are less expensive to make, differential SCSI devices can communicate over longer cables and are less susceptible to external noise influences. HVD SCSI has a higher cost associated with it. The 64 milliamp drivers required for differential (HVD) systems draw too much current to be able to drive the bus with a single chip. Single ended SCSI required only 48 milliamp drivers and can be implemented within a single chip. The high cost and low availability of differential SCSI devices also create a need for devices that convert single ended SCSI to differential SCSI such that both device types could coexist on the same bus. Differential SCSI along with its single ended alternative have reached the limits of what would be physically reliable in transfer rates, even though the flexibility of the SCSI protocol allowed for implementing much faster communications. Another problem has been the incompatibility between single ended and differential devices in the same system.

As the amount of data used and stored in systems is ever-increasing, there is a corresponding need to communicate greater quantities of data at ever-increasing speed.

### SUMMARY

A bus controller card capable of communicating high speed data between at least one host computer and at least one peripheral is provided. A first bus segment is connected between a first host connector, a first expander, a first card controller, a second expander, and a second host connector. A second bus segment extends from the first expander to a first backplane connector. A third bus segment extends from the second expander to a second backplane connector. At least one monitor bus segment is provided on the backplane to directly connect the first card controller to a second card controller on another bus controller card in the system. Each bus controller card is capable of determining whether cable connections to the bus interface card are properly mated; whether to enable an expander on the bus controller card; whether the bus controller card has primary or secondary status; and generating a signal to reset other components, including the other bus controller card, when one or more prespecified events are detected.

In one embodiment, an interface controller can operate in a dual port bus interface card or bus controller card (BCC). The BCC can couple to one or more host computers at a front end and to a backplane at a back end. Terminators can be connected to backplane connectors to signal the terminal end of the data bus. Proper functionality of the terminators depends on supply of sufficient “term power” from the data bus, typically supplied by a host adapter or other devices on the data bus.

Two interface cards or BCCs can be included in embodiments of a dual port system. At least one monitor bus is connected directly between two BCCs across the backplane to allow each BCC to monitor operations of the other BCC as well as other components in the system. The dual BCCs can each have a controller that executes instructions to monitor conditions and events, control the BCC, communicate status information and data to host computers, and support diagnostic procedures for various components of the system.

Each BCC can also include one or more bus expanders that allow a user to expand the bus capabilities. For example, an expander can extend cable lengths, isolate bus segments, increase the number of peripherals the system can access, and/or dynamically reconfigure bus components. The dual port bus BCCs can be arranged in multiple configurations including, but not limited to, two host computers connected to a single BCC in full bus mode; two BCCs in full or split bus mode and two host computers with each BCC connected to an associated host computer; and two BCCs in full or split bus mode and four host computers.

Various embodiments of the BCCs enable communication of high speed signals across one or more data buses in a communication system. The impedance and length of the signal traces for data bus segments are matched across one or more routing layers of a BCC's printed circuit board to help prevent corruption or loss of the high speed data signals. Trace width can be varied to match impedance, while trace length can be varied to match electrical lengths, and therefore data transfer speed. Signal trace stubs to components on a BCC can be minimized or eliminated by connecting the signal traces directly to the components instead of teeing off to them. Further, the length of bus segments can be minimized by positioning components as close together as possible.

Various other features and advantages of embodiments of the invention will be more fully understood upon consideration of the detailed description below, taken together with the accompanying figures.

### BRIEF DESCRIPTION OF THE DRAWINGS

FIG. 1A is a block diagram of a communication system showing an example of a bus architecture between one or more bus controller cards, peripheral devices, and host computers in accordance with an embodiment of the present invention.

FIG. 1B is a block diagram of an example of interconnections between components included on a bus controller card in accordance with an embodiment of the present invention.

FIG. 1C is a block diagram showing an example of a configuration of components, including monitor circuitry, for the communication system of FIG. 1A.

### DETAILED DESCRIPTION

To address deficiencies and incompatibilities inherent in the single-ended and high voltage differential physical SCSI interfaces, a bus interface architecture is provided that supports high speed signal transmission using Low Voltage Differential SCSI (LVD) drivers. LVD drivers utilize low cost elements of single ended interface while being capable of driving the bus reliably at faster data rates comparable to high voltage differential SCSI. The bus interface architecture includes features that provide the capability to determine enclosure configuration without monitoring the interface configuration across the backplane, and to avoid bus contention and possible data corruption.

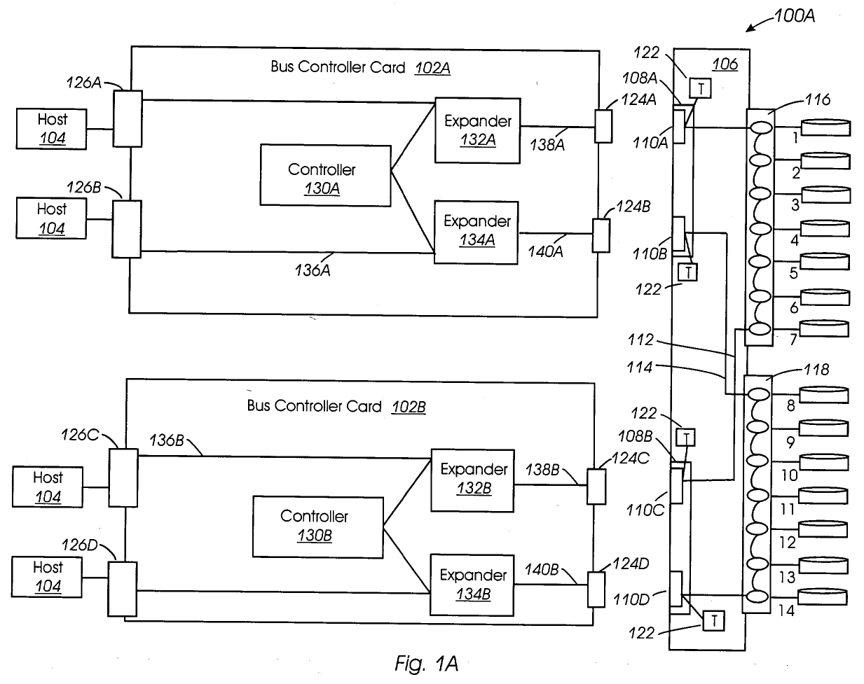

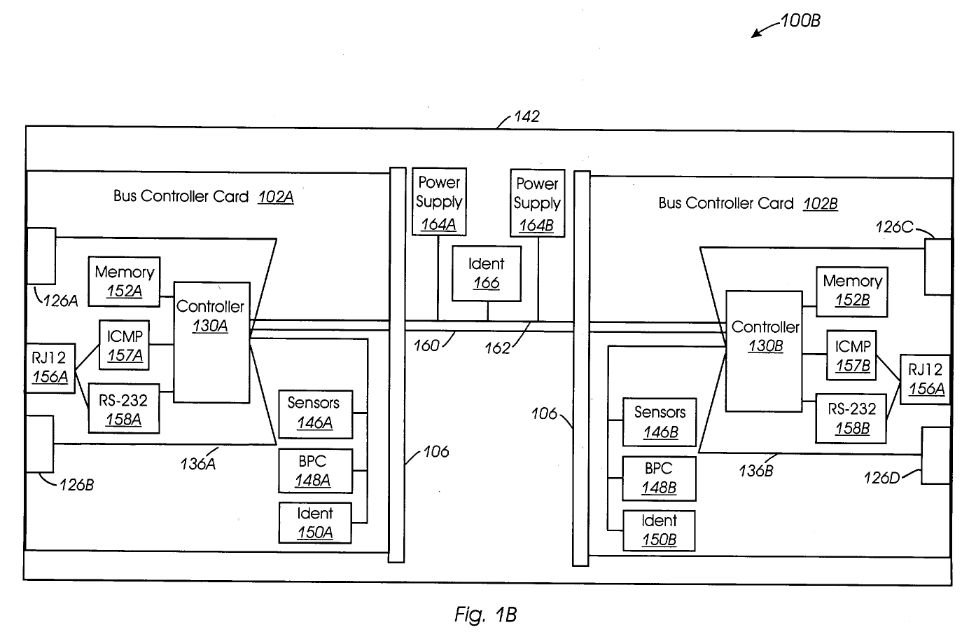

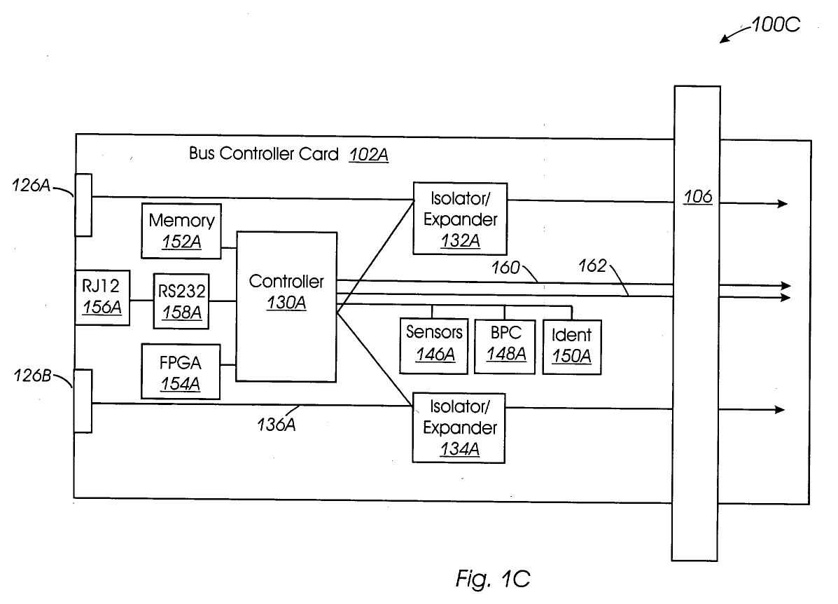

FIGS. 1A through 1C show diagrams of component systems 100A through 100C, respectively, which collectively illustrate a block diagram of data communication system 100 for high speed data transfer between peripheral devices 1 through 14 and host computers 104 via BCCs 102A and 102B in accordance with one or more embodiments of the present invention. Bus controller cards (BCCs) 102A and 102B are configured to provide the capability to transfer data at very high speeds, such as 160, 320, or more, megabytes per second, and to allow one of BCCs 102A and 102B to assume the data transfer responsibilities of the other BCC when the other BCC is removed or experiences a fault/error condition. To help accomplish this functionality, BCCs 102A and 102B include monitoring circuitry, as more fully shown in FIG. 1B and described herein, to detect events such as removal or insertion of the other BCC, as well as monitor operating status of the other BCC. When a BCC is inserted but experiencing a fault condition, the other BCC can reset the faulted BCC. Under various situations as further described herein, BCCs 102A, 102B can include one or more other logic components, such as shown in FIGS. 1C, 2, and 3A-3B, to hold the reset signal to prevent data transfers from being lost or corrupted until the components in system 100 are configured and ready for operation.

A SCSI expander is a device that enables a user to expand SCSI bus capabilities. A user can combine single-ended and differential interfaces using an expander/converter; extend cable lengths to greater distances via an expander/extender; and isolate bus segments via an expander/isolator. Expanders can also allow a user to increase the number of peripherals the system can access, and/or dynamically reconfigure components. For example, systems based on HVD SCSI can use differential expander/converters to allow a system to access a LVD driver in the manner of a HVD driver.

Referring now to FIG. 1A, BCCs 102A and 102B interface with backplane 106, which is typically a printed circuit board that is installed within other assemblies, such as a chassis (not shown) for housing peripheral devices 1 through 14, as well as BCCs 102A, 102B in some configurations. In certain embodiments, backplane 106 includes interface slots 108A, 108B with connector portions 110A, 110B, and 110C, 11D, respectively, that allow BCCs 102A and 102B to electrically connect to backplane 106.

Interface slots 108A and 108B (also referred to as bus controller slots 108A and 108B) are electrically connected and implemented to interact and communicate with components included on BCCs 102A, 102B and components of backplane 106, as shown. Generally, when multiple peripheral devices and controller cards are included in a system, such as system 100, various actions or events that affect the system's 100 configuration may take place.

In accordance with one aspect of system 100, controllers 130A and 130B include logic for configuring the status of BCCs 102A and 102B depending on the type of action or event taking place. These actions or events can include: attaching or removing one or more peripheral devices to or from system 100; attaching or removing one or more controller cards to or from system 100; removing or attaching a cable to backplane 106; and powering up system 100.

BCCs 102A and 102B can be fabricated using single or multi-layered printed circuit board(s), with the layers being designed to accommodate the required impedance for connections to host computers 104 and backplane 106. In some embodiments, BCCs 102A and 102B handle only differential signals, such as LVD signals to eliminate requirements for supporting single ended (SE) signals, thereby simplifying impedance matching considerations. Additionally, some embodiments of BCCs 102A and 102B allow data path signal traces on either internal layers or the external layers of the PCB, but not both, to avoid speed differences in the data signals. The width of the data signal traces on the BCC PCBs can be varied to match impedances at host connector portions 126A through 126D, and at backplane connector portions 124A through 124D.

A and B buses 112 and 114 on backplane 106 enable data communication between peripheral devices 1 through 14 and host computing systems, e.g., host computers 104, functionally coupled to backplane 106 via BCCs 102A, 102B. BCCs 102A and 102B, as well as A and B buses 112 and 114, can communicate using the SCSI communication protocol or other protocol. In some embodiments, A and B buses 112 and 114 are low voltage differential (LVD) Ultra-4 or Ultra-320 SCSI buses, for example. Alternatively, system 100 may include other types of communication interfaces and operate in accordance with other communication protocols.

A bus 112 and B bus 114 include a number of ports 116 and 118, respectively. Ports 116 and 118 can each have the same physical configuration. Peripheral devices 1 through 14, such as disk drives, for example, are adapted to communicate with ports 116, 118. The arrangement, type, and number of ports 116, 118 between buses 112, 114 may be configured in other arrangements and are not limited to the embodiment illustrated in FIG. 1A.

In some embodiments, connector portions 110A and 110C are electrically connected to A bus 112, and connector portions 110B and 110D are electrically connected to B bus 114. Connector portions 110A and 10B are physically and electrically configured to receive a first bus controller card, such as BCC 102A. Connector portions 110C and 110D are physically and electrically configured to receive a second bus controller card, such as BCC 102B.

BCCs 102A and 102B respectively include transceivers (not shown) that can convert the voltage levels of differential signals to the voltage level of signals utilized on a single-ended bus or can only recondition and resend the same signal levels. Terminators 122 can be connected to backplane connectors 110A through 110D to signal the terminal end of buses 112, 114. To work properly, terminators 122 use “term power” from bus 112 or 114. Term power is typically supplied by the host adapter and by the other devices on bus 112 and/or 114, including a local power supply. In one embodiment, the terminators 122 can be model number DS2108 terminators from Dallas Semiconductor.

In one or more embodiments, BCCs 102A, 102B include connector portions 124A through 124D, which are physically and electrically adapted to mate with backplane connector portions 110A through 110D. Backplane connector portions 110A through 110D and connector portions 124A through 124D should be impedance controlled connectors designed for high speed digital signals. In one embodiment, connector portions 124A through 124D are 120 pin count Methode/Teradyne connectors.

In certain embodiments, one of BCC 102A or 102B assumes primary status and acts as the central control logic unit that manages the configuration of system 100's components. When two or more BCCs are included in system 100, system 100 can be implemented to give primary status to a BCC in a predesignated slot. The primary and non-primary BCCs are substantially physically and electrically the same, with “primary” and “non-primary” denoting functions of the bus controller cards rather than unique physical configurations. Other schemes for designating primary and non-primary BCCs can be utilized.

In some embodiments, the primary BCC is responsible for configuring buses 112, 114, as well as providing other services such as bus addressing. The non-primary BCC is not responsible for configuring buses 112, 114, and responds to bus operation commands from the primary card, instead of initiating those commands itself. In other embodiments, the primary and non-primary BCCs can configure buses 112, 114, and initiate, as well as respond to, bus operation commands.

Typically, BCCs 102A and 102B can be hot-swapped, which is the ability to remove and replace BCC 102A and/or 102B without interrupting operation of communication system 100. The interface architecture of communication system 100 allows BCC 102A to monitor the status of BCC 102B, and vice versa. In some circumstances, such as hot-swapping, BCCs 102A and/or 102B perform fail-over activities to provide robust system performance. For example, when BCC 102A or 102B is removed or replaced, is not fully connected, or experiences a fault condition, the other BCC performs functions such as determining whether a change in a bus controller card's primary or non-primary status is required, setting signals to activate fault indications, and resetting BCC 102A or 102B. It should be noted that when more than two BCCs are included in system 100, the number and interconnections between buses on backplane 106 can vary accordingly.

Host connector portions 126A, 126B are electrically connected to BCC 102A. Similarly, host connector portions 126C, 126D are electrically connected to BCC 102B. Host connector portions 126A through 126D are adapted, respectively, for connection to a host device, such as host computers 104, for example. Host connector portions 126A through 126D receive voltage-differential input and transmit voltage-differential output. BCCs 102A and 102B can provide an independent channel of communication between each host computer 104 and communication buses 112, 114 implemented on backplane 106. In some embodiments, host connector portions 126A through 126D are implemented with connector portions that conform to the Very High Density Cable Interconnect (VHDCI) connector standard. Other suitable connectors that conform to other connector standards can be utilized.

Card controllers 130A, 130B can be implemented with any suitable processing device, such as controller model number VSC205 from Vitesse Semiconductor Corporation in Camarillo, Calif. in combination with FPGA/PLDs that are used to monitor and react to time sensitive signals. Card controllers 130A, 130B execute instructions to control BCC 102A, 102B; communicate status information and data to host computers 104 via a data bus, such as a SCSI bus; and can also support diagnostic procedures for various components of system 100.

BCCs 102A and 102B can include isolators/expanders 132A, 134A, and 132B, 134B, respectively, to isolate and retime data signals. Isolators/expanders 132A, 134A can isolate A and B buses 112 and 114 from monitor circuitry on BCC 102A, while isolators/expanders 132B, 134B can isolate A and B buses 112 and 114 from monitor circuitry on BCC 102B. Expander 132A communicates with backplane connector 124A, host connector portion 126A, and card controller 130A, while expander 134A communicates with backplane connector 124B, host connector portion 126B and card controller 130A. On BCC 102B, expander 132B communicates with backplane connector 124C, host connector portion 126B, and controller 130B, while expander 134B communicates with backplane connector 124D, host connector portion 126D and controller 130B.

Expanders 132A, 134A, 132B, and 134B support installation, removal, or exchange of peripherals while the system remains in operation. An isolation function monitors and protects host computers 104 and other devices by delaying the actual power up/down of the peripherals until an inactive time period is detected between bus cycles, thus preventing interruption of other bus activity. This feature also prevents power sequencing from generating signal noise, which can prevent data signal corruption. In some embodiments, expanders 132A, 134A, and 132B, 134B are implemented in an integrated circuit from LSI Logic Corporation in Milpitas, Calif., such as part numbers SYM53C180 or SYM53C320, depending on the data transfer speed. Other suitable devices can be utilized. Expanders 132A, 134A, and 132B, 134B can be placed as close as possible to backplane connector portions 124A through 124D to minimize the length of data bus signal traces 138A, 140A, 138B, and 140B.

The impedance for the front end data path traces from host connector portions 126A and 126B to card controller 130A is designed to match a cable interface having a measurable coupled differential impedance, for example, of 135 ohms. The impedance for the back end data path traces from expanders 132A and 134A to backplane connector portions 124A and 124B typically differs from the front end data path impedance, and may only be required to match a single-ended impedance, for example, of 67 ohms, which provides a decoupled differential impedance of 134 ohms. The layers of the printed circuit board (PCB) on which the BCCs 102A, 102B are implemented can be stacked to allow both types of traces to be provided on the same layers by simply changing the width of the traces to meet the impedance requirements.

In some embodiments, single ended devices are not allowed to be connected on the front end or the back end, thereby allowing the impedance for the differential traces to be based on the differential requirements only, instead of both the differential and single ended requirements. Some embodiments also require data path signals to be provided on either internal layers (referred to as “striplines”) or the outer layers (referred to as “microstrips”) of the BCC's PCB, but do not allow a mixture of stripline and microstrip data path signals to be used. The BCC's PCB is typically sized to allow use of standard mechanical interfaces, such as connectors and other standard interface cards.

In the embodiment shown in FIG. 1A, buses 112 and 114 are each divided into three segments on BCCs 102A and 102B, respectively. A first bus segment 136A is routed from host connector portion 126A to expander 132A to card controller 130A, to expander 134A, and from expander 134A to host connector portion 126B. A second bus segment 138A is connected between expander 132A and backplane connector portion 124A, and a third bus segment 140A is connected between expander 134A and backplane connector portion 124B. This architecture allows BCC 102A to connect to buses 112, 114 on backplane 106 if both isolators/expanders 132A and 134A are activated, or to connect to one bus on backplane 106 if only one expander 132A or 134A is activated. A similar data bus structure can be implemented on other BCCs, such as BCC 102B, which is shown with bus segments 136B, 138B, and 140B corresponding to bus segments 136A, 138A, and 140A on BCC 102A. BCCs 102A and 102B respectively can include transceivers (not shown) to convert the voltage levels of differential signals to the voltage level of signals utilized on buses 136A and 136B.

System 100 can operate in full bus or split bus mode. In full bus mode, all peripherals 1-14 are accessed by the primary BCC, and the secondary BCC if available. The non-primary assumes primary functionality in the event of a primary failure. In split bus mode, one BCC accesses data through a subset of peripherals 1-14 on A bus 112 while the other BCC accesses a mutually exclusive set of peripherals 1-14 through B bus 114. In some embodiments, a high and low address bank for each separate bus 116, 118 on backplane 106 can be utilized. In other embodiments, each port 116, 118 on backplane 106 is assigned an address to eliminate the need to route address control signals across backplane 106. When in split bus mode, monitor circuitry utilizes an address on backplane 106 that is not utilized by any of peripherals 1 through 14. For example, SCSI bus typically allows addressing up to 15 peripheral devices. One of the 15 addresses can be reserved for use by the monitor circuitry on BCCs 102A, 102B to communicate operational and status parameters to one another. BCCs 102A and 102B communicate with each other over out of band serial buses such as general purpose serial I/O bus.

When BCCs 102A and 102B are connected to backplane 106, system 100 operates in full bus mode with the separate buses 112, 114 on backplane 106 connected together. The non-primary BCC defined does not receive commands directly from bus 112 or 114 since the bus commands are sent to the non-primary BCC from the primary BCC. Other suitable addressing and command schemes can be utilized. Various configurations of host computers 104 and BCCs 102A, 102B can be included in system 100, such as, for example:

two host computers 104 connected to a single BCC in full bus mode;

two BCCs in full or split bus mode and two host computers 104, with one of host computers 104 connected to one of the BCCs, and the other host computer 104 connected to the other BCC; and

two BCCs in full or split bus mode and four host computers 104, such as shown in FIG. 1A.

In some embodiments, backplane 106 may be included in a Hewlett-Packard DS2300 disk enclosure and may be adapted to receive DS2300 bus controller cards, for example. The DS2300 controller cards utilize a low voltage differential (LVD) interface to the buses 112 and 114.

FIG. 1B show an embodiment of system 100 with components for monitoring enclosure 142 and the operation of BCCs 102A and 102B including card controllers 130A, 130B; sensors modules 146A, 146B; backplane controllers (BPCs) 148A, 148B; card identifier modules 150A, 150B; backplane identifier module 151; flash memory 152A, 152B; serial communication connector port 156A, 156B, such as an RJ12 connector port; and interface protocol handlers such as RS-232 serial communication protocol handler 154A, 154B, and Internet Control Message Protocol handler 158A, 158B. Together, these components monitor the status of and configuration of enclosure 142 and BCCs 102A, 102B; provide status information to card controllers 130A, 130B, and to host computers 104; and control configuration and status indicators. In some embodiments, the monitor circuitry components on BCCs 102A, 102B communicate with card controllers 130A, 130B via a relatively low-speed system bus, such as an Inter-IC bus (I2C). Other suitable data communication infrastructures and protocols can be utilized.

Status information can be formatted using standardized data structures, such as SCSI Enclosure Services (SES) and SCSI Accessed Fault Tolerant Enclosure (SAF-TE) data structures. Messaging from enclosures that are compliant with SES and SAF-TE standards can be translated to audible and visible notifications on enclosure 142, such as status lights and alarms, to indicate failure of critical components. One or more switches can be provided on enclosure 142 to allow an administrator to enable the SES, SAF-TE, or other monitor interface scheme.

Voltage, fan speed, temperature, and other parameters at BCCs 102A and 102B can be monitored by sensor modules 146A, 146B. One such set of sensors that is suitable for use as sensor modules 146A, 146B is model number LM80, which is commercially available from National Semiconductor Corporation in Santa Clara, Calif. In some embodiments, the Intelligent Platform Management Interface (IPMI) specification can be used to provide a standard interface protocol for sensor modules 146A and 146B. Other suitable sensor modules and interface specifications can be utilized.

Backplane controllers 148A, 148B interface with card controllers 130A, 130B, respectively, to provide control information and report on the configuration of system 100. In some embodiments, backplane controllers 148A, 148B are implemented with backplane controller model number VSC055 from Vitesse Semiconductor Corporation in Camarillo, Calif. Other suitable components can be utilized to perform the functions of backplane controllers 148A, 148B. Signals input to and output from backplane controllers 148A, 148B can include, among others:

disk drive detection;

identification of the primary or non-primary status of BCCs 102A, 102B;

enabling or disabling expanders 132A, 134A, 132B, 134B;

disk drive fault indicators;

audible and visual enclosure (chassis) indicators;

bus controller card fault detection;

bus reset control enable; and

power supply voltage and fan status.

Card identifier modules 150A, 150B provide information, such as serial and product numbers, of BCCs 102A and 102B to card controllers 130A, 130B. Backplane identifier module 166 also provides information about backplane 106, such as serial and product number, to card controllers 130A, 130B. In some embodiments, identifier modules 150A, 150B, and 166 are implemented with an electronically erasable programmable read only memory (EEPROM) and conform to the Field Replaceable Unit Identifier (FRU-ID) standard. Field replaceable units (FRU) include items which are hot swappable and can be individually replaced by a field engineer. A FRU-ID code can be included in an error message or diagnostic output indicating the physical location of a system component such as a power supply or I/O port. Other suitable identifier mechanisms and standards can be utilized for identifier modules 150A, 150B, and 166.

RJ-12 connector 156A allows connection to a diagnostic port in card controller 130A, 130B to access troubleshooting information and to download software and firmware instructions. RJ-12 connector 156A can also be used for an ICMP interface for test purposes.

Card controllers 130A and 130B can share data that assists monitoring degradation and potential failure of components in system 100. Monitor data buses 160 and 162 transmit data between card controllers 130A and 130B across backplane 106. The data exchanged between controllers 130A and 130B can include, among other signals, a periodic “heartbeat” signal from each controller 130A, 130B to the other to indicate that the other is operational, and a reset signal that allows a faulted BCC to be reset by another BCC. If the heartbeat signal is lost in the primary BCC, the non-primary BCC assumes the responsibilities of the primary BCC. The operational status of power supply 164A and a cooling fan (not shown) can also be transmitted periodically to controller 130A via bus 160. Similarly, bus 160 can transmit the operational status of power supply 164B and the cooling fan to controller 130B. In some embodiments, monitor data bus 160 is dedicated to transmitting data regarding power supplies 164A, 164B, while monitor data bus 162 is dedicated to transmitting heartbeat signals directly between card controllers 130A and 130B.

Warnings and alerts can be issued by any suitable method such as indicator lights on enclosure 142, audible tones, and messages displayed on a system administrator's console. In some embodiments, buses 160 and 162 can be implemented with a relatively low-speed system bus, such as an Inter-IC bus (I2C). Other suitable data communication infrastructures and protocols can be utilized in addition to, or instead of, the I2C standard.

Panel switches (not shown) and internal switches (not shown), may be also included on enclosure 142 for BCCs 102A and 102B. The switches can be set in various to configurations, such as split bus or full bus mode, to enable the desired functionality within system 100.

Referring to FIG. 1C, one or more logic units can be included on BCCs 102A and 102B, such as FPGA 154A, to perform time critical tasks. For example, FPGA 154A can generate reset signals and control enclosure indicators to inform system 100 or an administrator of certain conditions so that processes can be performed to help prevent loss or corruption of data. Such conditions may include, for example, insertion or removal of a BCC in system 100; insertion or removal of a peripheral; imminent loss of power from power supply 164A or 164B; loss of term power; and the removal of a cable from one of host connector portions 126A through 126D.

The instructions in FPGAs 154A, 154B can be updated by corresponding card controller 130A, 130B or other suitable means. Card controllers 130A, 130B and FPGAs 154A, 154B can monitor each other's operating status and assert a fault indication, as required, in the event non-operational status is detected. In some embodiments, FPGAs 154A, 154B includes instructions to perform one or more of the following functions:

Bus Resets

Reset on Peripheral Insertion/Removal (time critical)

Reset on Insertion/Removal of a Second BCC (time critical)

Reset on the Eminent loss of Power (time critical)

Reset on loss of termination power (time critical)

Reset on Cable or Terminator Removal from connector (time critical)

Miscellaneous Status and Control

Generation of Expander Reset (time critical)

Indication that BCC is Fully Inserted (time critical)

Driving the Disks Delayed Start Signal

Monitoring the BCC system clock and indicating clock failure with a board fault

Driving Indicators

Peripheral Fault indicator

Bus configuration indicator (e.g., full or split mode)

Term Power available indicator

SES indicator (SES being used to monitor the enclosure)

SAF-TE indicator (SAF-TE being used to monitor the enclosure)

Enclosure power indicator

Enclosure fault indicator (e.g., an FRU has failed)

A clock signal can be supplied by one or more of host computers 104, or generated by an oscillator (not shown) implemented on BCCs 102A and 102B. The clock signal can be supplied to any component on BCCs 102A and 102B.

Various embodiments of BCCs 102A and 102B provide advantages over known BCCs by enabling communication of high speed signals across separate buses 112, 114 on backplane 106. Alternatively, high speed signals from host connector portions 126A and 126B, or 126C and 126D, can be communicated across only one of buses 112, 114.

High speed data signal integrity can be optimized in illustrative BCC embodiments by matching impedance and length of the traces for data bus segments 136A, 138A, and 140A across one or more PCB routing layers. Trace width can be varied to match impedance and trace length varied to match electrical lengths, improving data transfer speed. Signal trace stubs to components on BCC 102A can be reduced or eliminated by connecting signal traces directly to components rather than by tee connections. Length of bus segments 138A and 140A can be reduced by positioning expanders 132A and 134A as close to backplane connector portions 124A and 124B as possible.

In some embodiments, two expanders 132A, 134A on the same BCC 102A can be enabled simultaneously, forming a controllable bridge connection between A bus 112 and B bus 114, eliminating the need for a dedicated bridge module.

The logic modules and circuitry described here may be implemented using any suitable combination of hardware, software, and/or firmware, such as Field Programmable Gate Arrays (FPGAs), Application Specific Integrated Circuit (ASICs), or other suitable devices. A FPGA is a programmable logic device (PLD) with a high density of gates. An ASIC is a microprocessor that is custom designed for a specific application rather than a general-purpose microprocessor. The use of FPGAs and ASICs improves the performance of the system over general-purpose CPUs, because these logic chips are hardwired to perform a specific task and do not incur the overhead of fetching and interpreting stored instructions. The logic modules can be independently implemented or included in one of the other system components such as controllers 130A and 130B. Similarly, other components on BCCs 102A and 102B have been discussed as separate and discrete components. These components may, however, be combined to form larger or different integrated circuits or electrical assemblies, if desired.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the components and their arrangement are given by way of example only. The configurations can be varied to achieve the desired structure as well as modifications, which are within the scope of the invention. Variations and modifications of the embodiments disclosed herein may be made based on the description set forth herein, without departing from the scope of the invention as set forth in the following claims.

In the claims, unless otherwise indicated the article “a” is to refer to “one or more than one”.

I claim:

1. A communication system comprising:
a bus controller card couplable to communicate with at least one host computer and at least one peripheral, wherein the bus controller card comprises:
a first card controller;
a first host connector portion;
a first expander and a second expander; and
a first bus segment extending from the first host connector portion, to the first expander, to the first card controller, and to the second expander.

2. The communication system of claim 1, further comprising:
a second host connector portion, wherein the first bus segment further extends from the second expander to the second host connector portion.

3. The communication system of claim 2, further comprising:
a first backplane connector portion; and
a second bus segment extending from the first expander to the first backplane connector portion.

4. The communication system of claim 3, further comprising:
a second backplane connector portion; and
a third bus segment extending from the second expander to the second backplane connector portion.

5. The communication system of claim 1, further comprising:
a first monitor bus segment extending from the first controller and couplable to a backplane.

6. The communication system of claim 5, wherein the first monitor bus segment conforms substantially to an 12C standard.

7. The communication system of claim 4, wherein at least one of the first, second, and third bus segments conform substantially to a SCSI standard.

8. The communication system of claim 5, wherein the first monitor bus segment is couplable to a second controller on a second bus controller card via the backplane.

9. The communication system of claim 8, further comprising:
a second monitor bus segment extending from the first controller, wherein the second monitor bus segment is couplable to the backplane to communicate with the second controller via the backplane.

10. The communication system of claim 8, further comprising:
at least one monitor circuit operable to monitor the operation of the communication system, wherein the monitor circuit is coupled to communicate performance data to the first controller.

11. The communication system of claim 10, wherein the first controller is operable to communicate at least a portion of the performance data to a host computer.

12. The communication system of claim 10, wherein the first controller is operable to communicate at least a portion of the performance data to the second controller via the first monitor bus segment.

13. The communication system of claim 12, wherein the backplane is couplable to at least one the group of a first peripheral via an even data bus and a second peripheral via an odd data bus.

14. The communication system of claim 13, wherein the even data bus is couplable to communicate with the first backplane connector portion and the odd data bus is couplable to communicate with the second backplane connector portion.

15. A bus controller card comprising:
a backplane comprising a plurality of data paths, wherein the backplane is configured to receive a first bus controller card and a second bus controller card, and further wherein the data paths are couplable to ports on the first and second bus controller cards; and
a monitor bus on the backplane, wherein the monitor bus is configured to enable direct communication between the first bus controller card and the second bus controller card.

16. The bus controller card of claim 15 wherein the data communicated via the monitor bus includes at least one of a heartbeat signal and a reset signal.

17. The bus controller card of claim 15 wherein the system includes logic instructions to detect actions including at least one of the group of: attaching and removing a peripheral device; attaching and removing the first and second controller cards; removing and attaching a cable to the backplane; and powering up the system.

18. The bus controller card of claim 15 further comprising the first bus controller card, wherein the first bus controller card is fabricated with a multi-layered printed circuit board (PCB), with data path signal traces on only one of the group of: internal layers of the PCB and external layers of the PCB.

19. The bus controller card of claim 18 wherein the width of the data path traces on the PCB is selected to substantially match impedances of devices connectable directly to the first bus controller card.

20. The bus controller card of claim 15, wherein one of the first and second bus controller cards is designated as the primary card to manage the components in the system, and the other of the first and second bus controller cards responds to bus operation commands from the primary card.

21. The bus controller card of claim 15 wherein at least one of the first bus controller card and the second bus controller card are hot-swappable.

22. The bus controller card of claim 15 further comprising logic to perform fail-over activities upon at least one of the following events: one of the first and second bus controller cards is removed; one of the first and second bus controller cards is replaced; one of the first and second bus controller cards is not fully connected; and one of the first and second bus controller cards experiences a fault condition.

23. The bus controller card of claim 15 comprising the first bus controller card, wherein the first bus controller card includes a first expander circuit and a second expander circuit.

24. The bus controller card of claim 23 wherein the expander circuits are positioned as close as possible to the backplane to minimize the length of data bus signal traces on the first bus controller card.

25. The bus controller card of claim 23 further comprising a first bus segment routed between a host connector, the first expander circuit, a card controller, the second expander circuit, and another host connector.

26. The bus controller card of claim 25 wherein a bridge connection is formed on the first bus controller card when the first and second expander circuits are active.

27. The bus controller card of claim 18 further comprising a second bus segment connected between the first expander and the backplane.

28. The bus controller card of claim 27 further comprising a third bus segment connected between the second expander and the backplane.

29. The bus controller card of claim 28 wherein the first bus controller card communicates with peripheral devices via two of the data paths on the backplane when the first and the second expander circuits are activated.

30. The bus controller card of claim 29 wherein the first bus controller card communicates with the peripheral devices via one of the data busses on the backplane when one of the first and second expander circuits are activated.

31. The bus controller card of claim 15 further comprising a first bus controller card, wherein the first bus controller card comprises at least one of a sensor module, a backplane controller, and a card identifier module.

32. The bus controller card of claim 31, further wherein the sensor module provides information regarding at least one of temperature, fan speed, and power to the first bus controller card; the backplane controller provides information regarding the configuration of the system; and the card identifier module provides information regarding the first bus controller card.

33. A method for communicating high-speed data between host computers and peripheral devices in a system, wherein a bus interface card is couplable between the host computers and the peripheral devices, the method comprising:
determining whether cable connections to the bus interface card are properly mated;
determining whether to enable an expander on the bus controller card;
determining the status of the bus interface card; and
generating a reset signal when a prespecified event is detected.

34. The method of claim 33, further comprising:
determining a configuration of the bus interface card between a full bus configuration and a split bus configuration;
determining a slot into which the bus interface card is inserted in the system; and
controlling operation of the expander based on the detected interface status, the bus configuration, and the lot.

35. The method of claim 33, further comprising:
determining the status of the bus interface card based on information from another bus interface card.

36. The method of claim 33, further comprising:
identifying a front end port state of the bus interface card from among Not Connected, Connected, Improperly Connected, and Faulted states.

37. The method of claim 33, further comprising:
determining whether term power is available within a predetermined voltage range; and
determining whether a differential sense signal is available within a predetermined voltage range.

38. The method of claim 33, wherein another bus interface card is couplable between the host computers and the peripheral devices, the method comprising:
communicating information between the bus interface cards via a monitor bus connected directly between the bus interface cards.

39. The method of claim 33, wherein generating the reset signal comprises:
determining whether a peripheral device has been inserted or removed from the system;
determining whether another bus interface card has been inserted or removed from the system;
determining the port connection status of each bus interface card in the system; and
determining whether a predetermined range of power is available to each bus interface card in the system.

40. A system for communicating high-speed data between host computers and peripheral devices, wherein a plurality of bus interface cards are couplable between the host computers and the peripheral devices, the method comprising:
means for determining whether cable connections are properly mated in the system;
means for determining whether to enable a first expander and a second expander on each bus controller card coupled to the system;
means for determining the status of the bus interface cards coupled to the system; and
means for resetting at least one of the bus interface cards coupled to the system when a prespecified event is detected.

41. The system of claim 40, further comprising at least one of:
means for determining a bus configuration of the bus interface cards coupled to the system.
means for determining a slot into which each bus interface card is inserted in the system; and
means for controlling operation of the expanders based on the detected interface status, the bus configuration, and the lot.

42. The system of claim 40, further comprising at least one of:
means for determining the status of the bus interface cards coupled to the system; and
means for designating one of the bus interface cards coupled to the system as a primary bus interface card.

43. The system of claim 40, further comprising:
means for identifying a front end port state of the bus interface cards coupled to the system from among Not Connected, Connected, Improperly Connected, and Faulted states.

44. The system of claim 40, further comprising at least one of:
means for determining whether term power is available within a predetermined voltage range; and
means for determining whether a differential sense signal is available within a predetermined voltage range.

45. The system of claim 40 further comprising:
means for communicating information between the bus interface cards via a monitor bus connected directly between the bus interface cards coupled to the system.

46. The system of claim 40, wherein generating the reset signal comprises at least one of:
means for determining whether a peripheral device has been inserted or removed from the system;
means for determining whether another bus interface card has been inserted or removed from the system;
means for determining the port connection status of each bus interface card in the system; and
means for determining whether a predetermined range of power is available to each bus interface card in the system.
